(19) United States
(12) Patent Application Publication
(10) Pub. No.: US 2025/0190564 A1
(43) Pub. Date: Jun. 12, 2025

(54) DETECTION OF ANOMALIES ASSOCIATED WITH INTERFERING PROCESSES

(71) Applicant: Microsoft Technology Licensing, LLC, Redmond, WA (US)

(72) Inventors: Amer Aref HASSAN, Kirkland, WA (US); Whitney J. Giaimo, Bellevue, WA (US); Edward C. Giaimo, III, Bellevue, WA (US)

(21) Appl. No.: 18/534,291

(22) Filed: Dec. 8, 2023

(51) Int. Cl. G06F 21/56; H04L 27/36

(52) U.S. Cl. CPC G06F 21/566; H04L 27/36; G06F 2221/033

(57) ABSTRACT

Methods and systems for detecting anomalous software behavior by monitoring frequency spectrums emanating from an electronic device are provided. A method includes storing frequency spectrum profiles for software applications and operational modes on the device. During execution of a software application, the real-time emanating frequency spectrum is measured and compared to the stored spectrum profile for that application and operational mode. Deviations between the real-time and reference spectrums indicate anomalous behavior from unknown software executing. The device determines a deviation exists and performs remedial actions like alerting the user, disconnecting from the network, shutting down, or switching application execution to another device. Frequency profiles are measured for new applications installed and stored to keep the data updated. Monitoring real-time frequency spectrums emanating from a device provides a computationally lightweight technique for detecting malicious software behavior without requiring complex analysis of application code.

### TECHNICAL FIELD

The present application relates to the technical field of detecting and mitigating unwanted or malicious software processes in electronic computing devices by monitoring and analyzing the electromagnetic frequency spectrum generated by an electronic computing device when executing various software applications while those software applications are operating in one of several operational modes or states.

### BACKGROUND

Electronic computing devices like personal computers, tablet computers, and mobile phones are vulnerable to malicious attacks and unauthorized access that can impair performance and compromise data security. With the proliferation of mobile computing devices, people are increasingly using these electronic devices for sensitive communications, posing heightened risks of exposing confidential information. Mobile operating systems and software applications may contain vulnerabilities allowing malware to secretly tap microphones, cameras, and communications undetected. This presents a major privacy and security concern. Existing detection techniques, which often rely on scanning files, network traffic, and memory for known “signatures” are computationally intensive. More efficient approaches are needed that can quickly detect anomalous resource usage and unauthorized access on a computing device, and mobile computing devices in particular. These approaches should minimize computational overhead. Moreover, effective techniques must be developed to detect unauthorized access to communication interfaces on mobile devices. This will help prevent exploitation by malicious actors seeking to compromise sensitive information.

### BRIEF DESCRIPTION OF THE DRAWINGS

Embodiments of the present invention are illustrated by way of example and not limitation in the figures of the accompanying drawings, in which:

FIG. 1 is a schematic diagram illustrating an example of common hardware components of a mobile or client computing device that are consistent with embodiments of the invention and capable of detecting malicious software processes by performing electromagnetic frequency spectrum analysis.

FIG. 2 is a diagram illustrating a detailed view of an example of a communications system component of a mobile computing device including a spectral analyzer for deriving a frequency spectrum, consistent with some embodiments.

FIG. 3 is a diagram illustrating an example of a database of reference frequency spectrums or frequency spectrum profiles, where each individual frequency spectrum profile represents an expected frequency spectrum to be exhibited by a computing device when executing a software application known to be executing in a particular operational mode or state for a given time period, consistent with some embodiments.

FIGS. 4A and 4B are diagrams illustrating examples of comparisons of an observed frequency spectrum and expected frequency spectrum, consistent with some embodiments.

FIG. 5 is a flow diagram illustrating an example of a method for detecting anomalies based on a comparison of an expected frequency spectrum with an actual or observed spectrum, consistent with embodiments of the invention.

FIG. 6 is a block diagram illustrating a software architecture, which can be installed on any of a variety of computing devices to perform methods consistent with those described herein.

FIG. 7 illustrates a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are methods and systems for detecting and mitigating unwanted or malicious software processes in electronic computing devices by monitoring and analyzing the frequency spectrum exhibited by a computing device when the device is executing a software application that is operating in a known state or mode. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

Malicious software processes such as viruses, worms, and trojans are especially problematic when leveraged to spy on users by illicitly tapping into unified communications facilitated by software applications. Here, the concept of unified communications refers to the integration of modalities like voice, video, messaging, screen sharing and conferencing into software applications that provide seamless workflows between users across devices and platforms. When malware is able to stealthily intercept or access these communications, it enables spying and surveillance that severely compromises user privacy and security. For example, an undesirable software process could unknowingly tap into a software video conferencing application to silently eavesdrop on a meeting, by redirecting a stream of data to the computing device of a bad actor. Similarly, a virus might be able to access messages sent through a chat or text-based messaging application and secretly forward copies of sensitive conversations to unauthorized parties. This type of tapping by malware to spy on unified communications channels represents a dangerous threat, yet detection using conventional security techniques has proven challenging.

Signature-based detection techniques have been used as one approach for identifying malware and undesirable processes on computing devices. With signature-based detection, unique patterns or identifiers associated with known threats and undesirable processes are pre-defined and stored in a database. These signatures may be based on aspects such as specific code sequences, instruction opcodes, network traffic patterns, file modifications, registry edits, or other artifacts and behaviors indicative of a specific threat. To detect threats, software applications will scan target code, network packets, memory, and storage, looking for matches to these pre-defined signatures. Typically fast pattern matching algorithms are utilized to efficiently search for signature matches within the target data. Signature detection forms the basis for many antivirus and intrusion detection systems on computing platforms.

However, signature-based approaches have several notable disadvantages. Signature detection requires the ongoing maintenance of a large database containing signatures for known threats and frequent updates to this database as new threats are discovered. Fundamentally, signature detection can only identify threats for which a signature has already been identified and cataloged. The scanning process itself consumes significant processing resources, often utilizing intensive computation to search for many possible signature matches within the target data. Consequently, this scanning significantly increases power consumption, which is especially prohibitive on battery-constrained mobile platforms. Additionally, signature detection techniques cannot generalize to detect zero-day threats or polymorphic malware that alters its code patterns to evade signatures. Signature-based approaches are further susceptible to evasion through obfuscation or modification of the attack's identifiable patterns and artifacts.

Another approach to detecting malware involves heuristic-based detection techniques. Heuristic-based detection techniques take a more analytical approach to identifying malware and unwanted processes, in contrast to strict signature matching. With heuristic-based detection, algorithms are used to evaluate various properties associated with executable files, system behaviors, and other artifacts. These algorithms apply heuristics to analyze factors like file metadata, structure, binary patterns, API and system calls, network communications, registry and file system access, and more. The goal is to detect artifacts and behaviors that appear anomalous or “suspicious” based on heuristics that characterize normal or benign system activities. This enables the algorithms to flag unknown threats that may lack a specific signature match. Heuristic detection is generally less precise than signature matching, however it can potentially identify novel threats.

However, heuristic-based detection still retains some notable disadvantages that limit its effectiveness and applicability. The heuristic algorithms require significant processing overhead to analyze the various factors and make probabilistic determinations on threats. This processing overhead consumes substantial computing resources and battery on mobile platforms. The algorithms also have a tendency to generate false positives for benign system events that happen to match heuristic rules for suspicious activity. Tweaking the heuristics to reduce false positives risks increasing false negatives and missing threats. Further, threat actors can potentially analyze the detection algorithms and craft malware that avoids triggering heuristic rules. While heuristic detection has advantages over strict signature matching, it remains a computationally demanding approach with accuracy challenges.

Consistent with embodiments of the present invention, an anomaly-detection based approach, having two primary stages or parts, is described. During a first stage, a local database of reference frequency spectrums also referred to herein as frequency spectrum profiles, is created on a target device, where each frequency spectrum profile represents an expected frequency spectrum for a given software application operating in a specific operational mode or state. Here, an operational mode or state may be a communication mode, such as during an audio, video, screen sharing, or other communication modes of unified communications. By way of example, a fast Fourier transform (FFT) algorithm can be applied to complex baseband samples obtained at the output of a baseband modulator of a communications system component while a software application is executing in a specific communications mode. The FFT analysis converts the time-domain baseband samples into the frequency domain, thereby generating a measured frequency spectrum profile that can be stored as the reference frequency spectrum for that software application operating in that specific communication mode.

The second stage involves real-time anomaly detection, where the frequency spectrum observed during operation of the device is continually measured and compared against an expected frequency spectrum (e.g., a reference spectrum) for an application currently executing in known communication modes. Deviation between observed and expected spectrums for a sufficient amount of time, during operation in a known communication mode or state, indicates potential interference from malware or other unwanted processes, triggering alerts or other actions. By combining pre-characterization of per-application frequency spectrums, for applications executing in specific communication modes, with runtime monitoring and comparison, embodiments of the invention provide an effective approach to detecting anomalous spectrum behavior suggestive of malicious activity.

The reference frequency spectrums that characterize software applications operating in various communications modes or states can be derived in at least one of two ways. First, the reference frequency spectrum may be pre-characterized on a known clean test machine that is free of any malware or interfering processes. The target software applications are individually profiled in isolation to generate the characteristic reference frequency spectrum for each of several communication modes—for example, during audio calls, video calls, screen sharing sessions, messaging, or other modes of communication available in unified communications platforms. These reference frequency spectrums are then transferred and installed on the target devices that will utilize them for monitoring operations. Alternatively, the profiling software that derives the reference frequency spectrums can reside directly on the target device itself. During initial setup when the device is known to be secure, the profiling software methodically exercises the various applications in different communication modes, for example, placing test calls and making synthetic communications, while measuring the resulting frequency spectrums to populate the reference frequency spectrum database with entries mapping software application and communication modes to expected frequency spectrums. Once the target device reference spectrums have been compiled, the software may disable further modification to prevent tampering. Alternatively, the profiling process may periodically re-execute on a scheduled basis to re-measure and confirm the prior reference spectrums, generating a notification flag if any updated spectrum deviates from an original by more than a defined threshold amount.

Importantly, when the frequency spectrum profiles are generated on a known clean test machine, the reference frequency spectrums are constructed for the specific target device hardware configuration, since factors like the CPU, network interface, GPU, etc. will influence the resulting frequency spectrum. The same software application executing a video conferencing mode on two different computing devices may exhibit different frequency spectrums. Once generated on the clean machine, the database of reference frequency spectrums can be transferred to the target device for monitoring operations. By profiling expected frequency spectrums for software communication modes on the target hardware, any runtime deviations in the spectrum can be flagged as anomalies.

In some embodiments, a remote server-based service may maintain a comprehensive database containing frequency spectrum profiles for a wide variety of computing device hardware configurations and software versions. When the profiling software first executes on a target client device, it can communicate details of the device's hardware components (e.g. CPU model, GPU model, amount of RAM, etc.) and software versions to the remote service. The service can then query its database and identify the appropriate frequency spectrum profiles that match the target device's configuration. These matched frequency spectrum profiles are then downloaded and installed locally on the target device for use in monitoring and anomaly detection. By leveraging a remote server-based service in this manner, the system can support anomaly detection across many different device models and platforms while avoiding the need to individually profile each target device from scratch.

The frequency spectrum profiles that characterize software applications while operating in specific communication modes can be represented in different ways, and may vary based on whether a software application is executing in a steady communication mode—that is, in the same communication mode over a given period of time—or alternatively, transitioning between communication modes. One approach is to define the expected frequency spectrum for a given communication mode of a software application using a set of dominant frequencies and their amplitudes that characterize that mode. These dominant frequencies may be derived by averaging observed spectrums from several sample measurements over some brief period of time while operating stably in the communication mode, recognizing that there may be slight variations over time. Factors like computational load, data rate, and environmental conditions can cause minor fluctuations in dominant frequencies around average values.

As an alternative to specifying a frequency spectrum profile as a set of discrete dominant frequency values, frequency ranges can be specified to provide tolerance for routine fluctuations during operation. Defining the anticipated frequencies for a software application's communication mode using ranges enables the same overall spectrum behavior to be captured without flagging normal variations as anomalies. Specifying expected frequency spectrums as ranges rather than discrete values also allows the sensitivity of anomaly detection to be tuned based on the range size. A narrow frequency range will detect smaller deviations, while a wider range may ignore insignificant fluctuations and only identify meaningful anomalies outside the range. The appropriate range size can be determined experimentally for each communication mode to optimize detection accuracy.

Whether represented as discrete frequency values or ranges, the frequency spectrum profiles characterize baseline spectrum behavior for software applications operating in different communication modes. To detect anomalies, the frequency spectrum profiles or reference spectrums for actively executing and communicating applications are analyzed. For example, if a software application is executing and utilizing a video communications mode via which a user is having a video conference, the reference frequency spectrum for the specific software application in the specific communication mode is retrieved. The reference spectrum is then compared to the actual overall observed spectrum. If the observed spectrum significantly deviates from the expected spectrum, this deviation indicates potential interference from malware or other unwanted processes. By combining the individual application frequency spectrum profiles and comparing to real-time measurements, the system can reliably detect anomalies caused by interference from malicious background activities.

The techniques described herein for monitoring frequency spectrum profiles to identify anomalies are especially useful for detecting malicious software surreptitiously tapping into communications channels. By clandestinely accessing microphones, cameras, messaging systems, and other communication modalities facilitated by software applications, malware can intercept or redirect private voice, video, text, and media communications without user awareness. Since the reference frequency spectrum profiles characterize expected behavior when software applications utilize various communication modes, any deviation caused by malware interference will be detectable as an anomaly. For example, if a virus has tapped into a video conferencing application to intercept communications that are part of a video-based meeting, the resulting frequency spectrum will diverge from the reference spectrum for that software application engaging in standard video communication. The system can thus reliably detect when unauthorized software is illicitly accessing communication channels, enabling alerts and other responsive actions.

However, in an alternative embodiment, the techniques described herein can also be used to detect the execution of malicious software even when no active communications are occurring. Even if a software application is idle and not presently transmitting or receiving voice/video/text/media data, malicious processes running surreptitiously in the background can still be identified by anomalies in the frequency spectrum. Consistent with some embodiments, each software application has characteristic frequency spectrum profiles not only for communication modes, but also for background execution with no active communication. For example, a messaging application when idle may exhibit a relatively narrow frequency spectrum profile concentrated around the clock speed. If other processes are executing within the messaging application unbeknownst to the user, additional frequency components may appear that diverge from this reference profile, allowing the anomaly to be detected. By continually monitoring for deviations from reference frequency spectrum profiles associated with software applications in both communicating and non-communicating states, the system provides comprehensive detection coverage for malware.

In this alternative embodiment focused on identifying background execution of malicious processes, individual hardware components can also be analyzed for anomalous frequency profiles even without active communications occurring. For instance, the frequency spectrum emanating solely from the network interface card can be measured independently and compared to a reference profile characterizing the hardware component when no unintended software is running. Similarly, independent analysis of the spectrum contributions from other system elements like the CPU/GPU, memory controllers, disk drives, etc. can pinpoint anomalies from specific subsystems that may have malware actively leveraging their capabilities outside of intentional communications. By expanding anomaly detection to frequency profiles of both software applications and device hardware components in isolation, embodiments of the invention can catch malicious background processes that evade techniques limited to only inspecting communication channels.

Malicious software tapping into communications channels presents a technical problem. Unwanted and malicious applications may covertly access microphones or cameras without user awareness to intercept private voice, video, or text communications. Alternatively, malware may inject data into existing communications, compromising their integrity. From a technical perspective, these security breaches are only possible due to vulnerabilities in allowing software unfettered access to communication device hardware and channels. No robust technical means to detect or prevent unauthorized access currently exists. Therefore, the problem of malware tapping communications is fundamentally technical in nature. The present invention provides a technical solution to this problem by leveraging the principles that execution of software instructions and communication activities exhibit detectable electrical and radio frequency signatures. By deeply integrating power and frequency spectrum analysis into the device hardware and operating system itself, the present invention offers the capability to reliably detect application behaviors that are surreptitiously accessing or manipulating communication channels through precise technical measurement and detection techniques. The solution is intrinsically and uniquely technical, stemming from electrical engineering and signal processing innovations. Other aspects and advantages if the various embodiments of the invention will be readily apparent from the description of the several figures that follows.

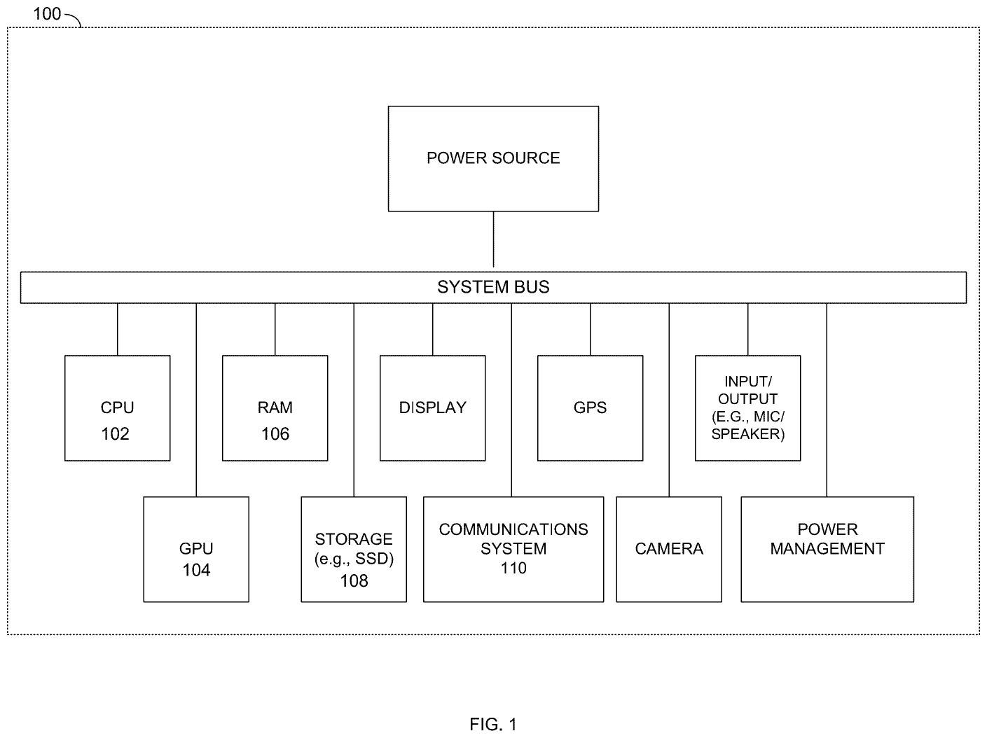

FIG. 1 is a schematic diagram illustrating an example of common hardware components of a client computing device 100 consistent with embodiments of the invention and capable of detecting malicious software processes via monitoring and analysis of frequency spectrums. The computing device 100 depicted in FIG. 1 includes various hardware components that collectively exhibit different frequency spectrums when the device 100 is executing different software applications operating in various modes or states. These components include, for example, the central processing unit (CPU) 102, graphics processing unit (GPU) 104, random access memory (RAM) 106, storage 108, communications system 110, and others.

The computing device 100 includes functionality to identify software applications currently executing on the device and determine the operational mode or state of each application. This can be accomplished using standard operating system APIs and functions to get lists of running processes and track resource utilization. The application tracking component provides the ability to maintain real-time knowledge of active software applications and their modes, as needed to drive the anomaly detection approach.

The computing device and components depicted in FIG. 1 provide just one example implementation consistent with some embodiments of the invention. Various alternatives and integrated component architectures could be implemented without departing from the spirit of the techniques described herein for frequency spectrum monitoring to detect anomalies. Furthermore, while the techniques described herein can be applied to any computing device, they are particularly applicable to client computing devices that may be vulnerable to malware, such as phones, tablets, laptops, and desktop computers. For these client devices that handle private user data and communication, unauthorized surveillance and access poses a major security risk. However, the invention could also be applied to improve security on server-based computing systems facing risks from viruses, worms, and unauthorized access. Applying frequency spectrum monitoring on servers provides another layer of protection to ensure critical business systems and data remain secure from anomalies and unwanted processes.

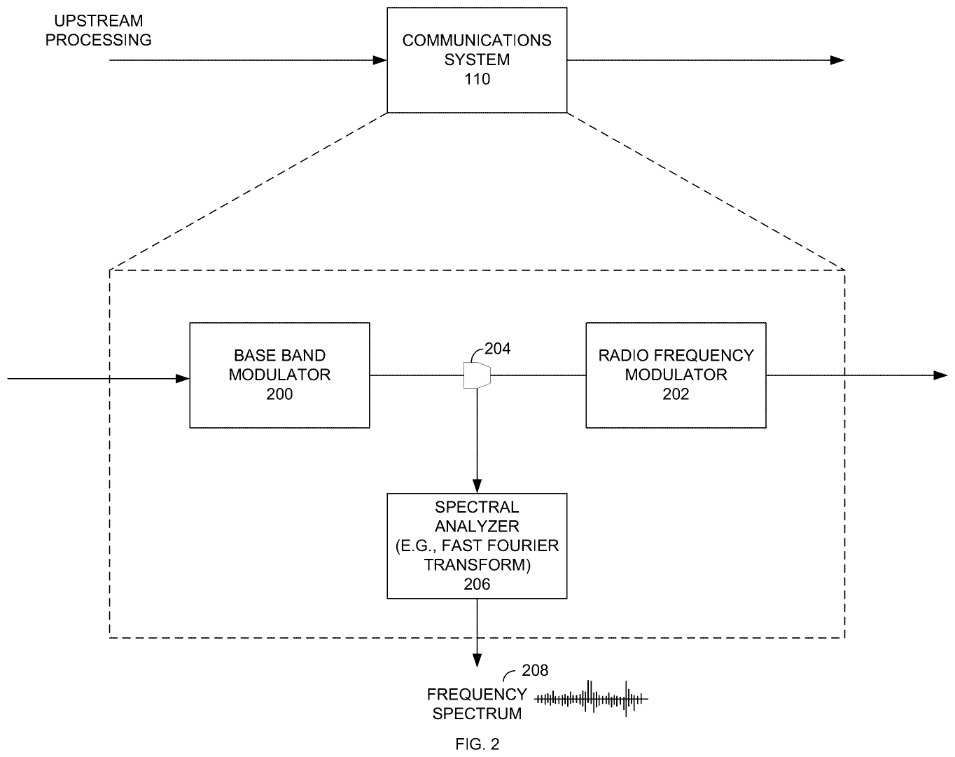

FIG. 2 illustrates a detailed view of a communications system component 110, consistent with some embodiments. Within the communications system component 110 is a baseband modulator 200 that receives digital data from upstream processing components and modulates the data into a complex baseband waveform suitable for transmission, for example, by the radio frequency (RF) modulator 202. The baseband modulator 200 encodes information in the amplitude and phase of the baseband waveform it generates. Its output consists of a time sequence of complex numerical samples that represent the baseband signal.

The RF modulator 202 receives the baseband waveform output from the baseband modulator 200 and upconverts the signal to an RF carrier frequency suitable for over-the-air propagation to an intended receiver. The RF modulator 202 imprints the amplitude and phase encoded baseband signal onto a higher frequency sinusoidal carrier wave via modulation techniques such as quadrature amplitude modulation (QAM). The RF modulator 202 outputs an RF waveform at the target transmit frequency that carries the data encoded in the baseband signal provided to it.

A switch 204 is included that allows the output from the baseband modulator 200 to be selectively directed either to the RF modulator 202 for transmission to an external device, or alternatively to a spectral analyzer component 206. Consistent with some embodiments, the spectral analyzer 206 applies a Fast Fourier Transform (FFT) algorithm to the baseband samples to convert the complex time-domain baseband signal into the frequency domain. The FFT rapidly computes the discrete Fourier transform of the baseband signal using efficient computational techniques to reveal its frequency spectrum characteristics. The switch 204 enables real-time computation of the transmit data frequency spectrum for anomaly detection without needing to actually propagate an RF transmission if desired.

Alternatives to the FFT for converting the baseband time-domain signal into a frequency spectrum include the Discrete Fourier Transform (DFT), various optimized FFT algorithms, chirp-Z transform, wavelet transform, Hilbert transform, and parametric methods. The DFT is a simpler Fourier analysis technique closely related to the FFT. Optimized FFT enhancements include algorithms like the Goertzel algorithm or Lomb-Scargle algorithm, which can reduce computational requirements. The chirp-Z transform offers configurable frequency resolution. Wavelet transforms provide localization in both time and frequency. Hilbert transforms extract quadrature components. Parametric methods estimate the spectrum based on signal models rather than direct transformation.

These alternatives involve various tradeoffs between performance, flexibility, accuracy, and complexity. The FFT provides an efficient implementation for frequency spectrum analysis that enables real-time monitoring suitable for anomaly detection during software execution with moderate computing resource utilization.

The output of the spectral analyzer 206 is provided to an anomaly detection component (not shown) that compares the measured or observed frequency spectrum to an expected reference frequency spectrum that corresponds to the specific software application presently executing and its current communication mode. For example, if a video conferencing application is actively operating in a screen sharing mode, the appropriate reference spectrum representing the video conferencing application executing in screen sharing mode is selected from a database of reference spectrum profiles. The anomaly detection component analyzes the real-time measured spectrum emanating from the device against the selected reference spectrum, using statistical comparison techniques. If the observed spectrum significantly diverges from the expected reference spectrum based on threshold tests, this indicates a potential malware interference causing an anomalous spectrum. By matching each application's frequency spectrum profile for specific communication modes against real-time measurements, the system can reliably detect spectrum anomalies suggestive of surreptitious malicious activities.

The anomaly detection component may interface with the operating system to trigger alerts or other actions responsive to detecting an anomalous spectrum deviation event. Moreover, the specific response that is triggered may be dependent upon the degree of divergence between the measured spectrum and expected reference spectrum. More significant deviations, quantified by statistical metrics like spectral distance or variance, may necessitate more disruptive actions like terminating processes or disabling network connectivity. Minor anomalies may only result in logging the event or warning the user. By calibrating the response based on the magnitude of the spectral deviation rather than just binary anomaly detection, embodiments of the invention can implement response policies tailored to the likelihood and estimated severity of the threat.

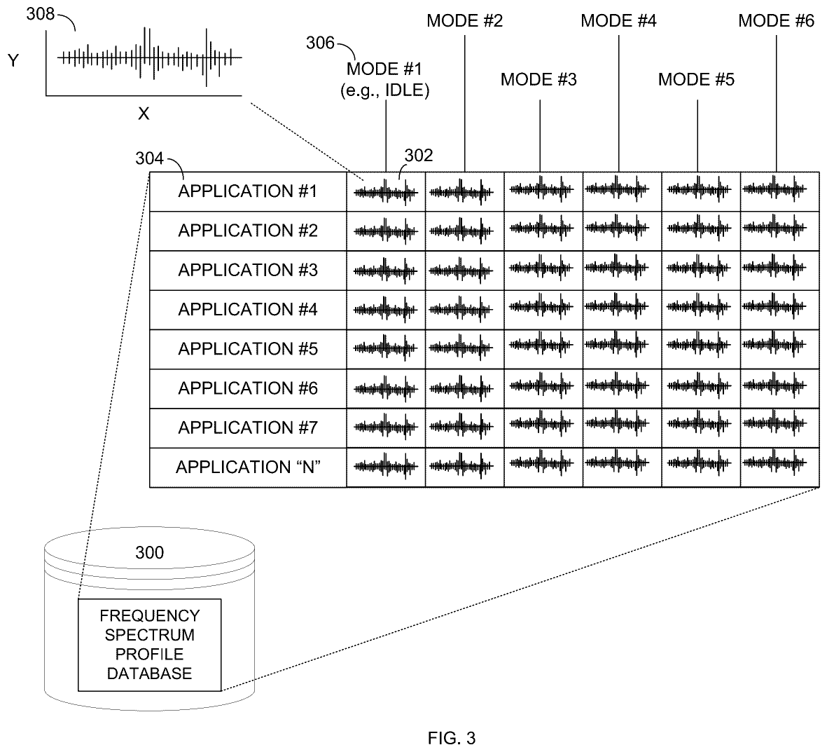

FIG. 3 is a diagram illustrating an example of a database 300 of frequency spectrum profiles, where each individual spectrum profile represents an expected frequency spectrum attributable to a software application known to be executing in a particular operational mode or state, consistent with some embodiments. Specifically, FIG. 3 depicts an example frequency spectrum profile database 300 containing a number of entries—for example, such as the entry with reference number 302—where each entry 302 corresponds with a software application operating in a specific operational mode or state. For example, the frequency spectrum profile corresponding with the table entry with reference 302 is the frequency spectrum profile for the software application 304 (e.g., “APPLICATION #1”) operating in a first operational mode 306 (e.g., “MODE #1”).

For a given application 304, the database 300 contains one or more frequency spectrum profiles, where each profile indicates an expected frequency spectrum attributable to execution of the corresponding software application in the associated operational state. The graph 308 shown in the upper left section of FIG. 3 provides a visual representation depicting the frequency spectrum profile for the software application 304 (e.g., “APPLICATION #1”) executing in a particular operational mode 306 (e.g., “MODE #1”).

In the example illustrated in FIG. 3, the software application 304 (“APPLICATION #1”) has six frequency spectrum profiles, each representing an expected frequency spectrum attributable to the application executing in one of six different operational modes, labeled as “MODE #1” through “MODE #6”. When the software application 304 is executing in the first mode 306, which could represent an idle state, the expected frequency spectrum profile may comprise frequencies F1, F2 and F3 with amplitudes A1, A2 and A3. In a second mode (e.g., “MODE #2”), which could be an audio communication state, the expected frequency spectrum profile comprises frequencies F4, F5, F6 and F7 with amplitudes A4, A5, A6 and A7. The other modes—for example, “MODE #3” through “MODE #6”—each have associated expected frequency spectrum profiles characterized by additional sets of frequencies and amplitudes.

A software application executing on a computing device operates in various operational modes or states. In the context of the present application, an operational mode or state refers to the software application operating to perform a particular function, task, or operation at a given time. For instance, common operational modes or states for applications may include:
Idle—The application is open but not being actively used.
Active Communication—The application is facilitating an active communication session like an audio call, video call, chat/messaging, or conference call.
Media Playback—The application is playing or streaming video or audio content.
Gaming—The application is executing an interactive game application.
File Transfer—The application is actively downloading or uploading data.
Video Playback—Playing locally stored video content.
Audio Playback—Playing locally stored audio content.
Computational Task—The application is performing intensive computations.
Transition—The application is transitioning from one operational state to another.

The above list represents common operational modes or states but is not exhaustive. Additional application-specific operational modes or states are also possible. The frequency spectrum profile varies based on the particular operational state.

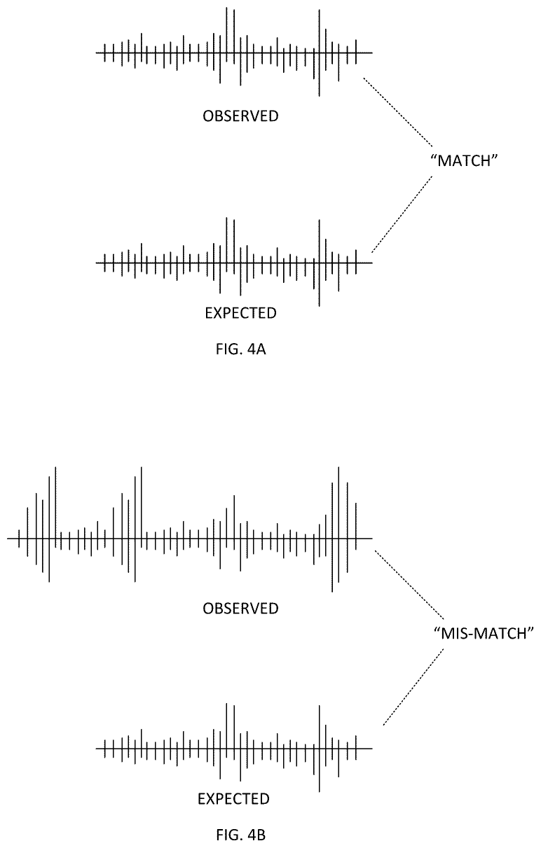

FIG. 4A illustrates an example where the observed real-time frequency spectrum 400 emanating from an electronic device closely matches the reference frequency spectrum profile 402 retrieved for the software application executing in its detected operational mode. As shown in FIG. 4A, the amplitude and frequency values for multiple spectral components in the observed spectrum align very closely to the expected amplitude and frequency values for the same components in the reference spectrum profile. This alignment represents a match between the expected and observed frequency spectrums.

Several different techniques may be used to determine the existence of a match between the expected and observed frequency spectrums. One approach is to calculate a spectral deviation metric that quantifies the overall difference between the observed spectrum and reference spectrum over a time window. For example, a mean square error (MSE) metric could compare the amplitude values for each frequency bin between the two spectrums. The MSE averages the squared errors across the frequency range to compute a single numeric deviation score for that time snapshot.

This MSE spectral deviation metric can be tracked over consecutive time windows, such as over 10 consecutive one-second intervals. A threshold level for the MSE score may be established through empirical testing and calibration. For instance, a threshold may be set at an MSE (e.g., 5 dB) based on observed scores during normal operation. The system could determine a match exists only if the MSE remains below the threshold for at least 7 out of the 10 recent sampling windows. If the MSE exceeds the threshold over a majority of windows, this persistent deviation would indicate an anomaly. In addition to simple threshold tests on the calculated spectral deviation metric, more advanced pattern matching algorithms could also be applied to assess similarities between the observed and reference frequency spectrums over time.

By contrast, FIG. 4B shows an example where a significant deviation exists between the observed real-time frequency spectrum 404 and the expected reference frequency spectrum profile 406. As shown in FIG. 4B, while some frequency components in the observed spectrum match those in the reference spectrum profile, several other prominent frequency components in the observed spectrum are substantially different in amplitude from the expected reference spectrum. This mismatch indicates that the observed emanating frequency spectrum for the electronic device differs markedly from anticipated spectrum behavior for the software application in its detected operational mode.

The determination of whether an observed real-time frequency spectrum matches or mismatches a reference frequency spectrum profile is made through statistical comparison of the spectral components over multiple time intervals. Individual frequency and amplitude values may fluctuate slightly over time even for normal expected system behavior. To account for these minor variations, the observed frequency spectrum is compared to the reference spectrum repeatedly over multiple time windows, for example over “X” consecutive one-second intervals. Statistical matching criteria are applied to allow some tolerance in deviation across the time intervals before concluding a definitive mismatch exists.

If the deviation between observed and reference spectrums is within fluctuation tolerance levels for a majority of the time intervals, as shown in FIG. 4A, then the system determines the spectrums match. However, if the disparity persists across multiple time windows at levels beyond normal fluctuation bounds, as shown in FIG. 4B, this substantial and sustained mismatch signifies a possible anomaly that may indicate malicious operations from unauthorized software executing on the device.

Consistent with some embodiments, the specific remedial action initiated by the computing device following the detection of a deviation between observed and reference frequency spectrums depends on the calculated degree of mismatch. A greater disparity or mismatch signifies a higher likelihood that unauthorized or malicious software is actively executing on the device. In cases of extreme deviation indicating a very high probability of malware, disruptive actions like fully disconnecting the device's network connectivity or even a forced shutdown of the device may be automatically triggered.

However, in less severe cases where the mismatch suggests but does not definitively confirm malicious software activity, less disruptive actions are taken. For a minor deviation, the device may simply log the anomaly event and timestamp it for future analysis. For moderate deviations, the device may provide a notification to the user indicating the detection of suspicious activity and prompting the user to run a system diagnostic. Alternatively, with an intermediate level mismatch, the device may automatically execute detailed system checks like forensic analysis of running processes, ports and network connections, file modifications, and registry edits to identify evidence corroborating the potential threat.

By calibrating the response proportional to the calculated severity of the anomaly, only extreme events necessitate disruptive actions while minor deviations trigger non-intrusive notifications and diagnostics. This allows the system to balance security with usability. The thresholds and criteria for classifying deviation severity and selecting appropriate remediation actions may be determined experimentally for each device configuration to optimize this tradeoff between disruption and vigilance.

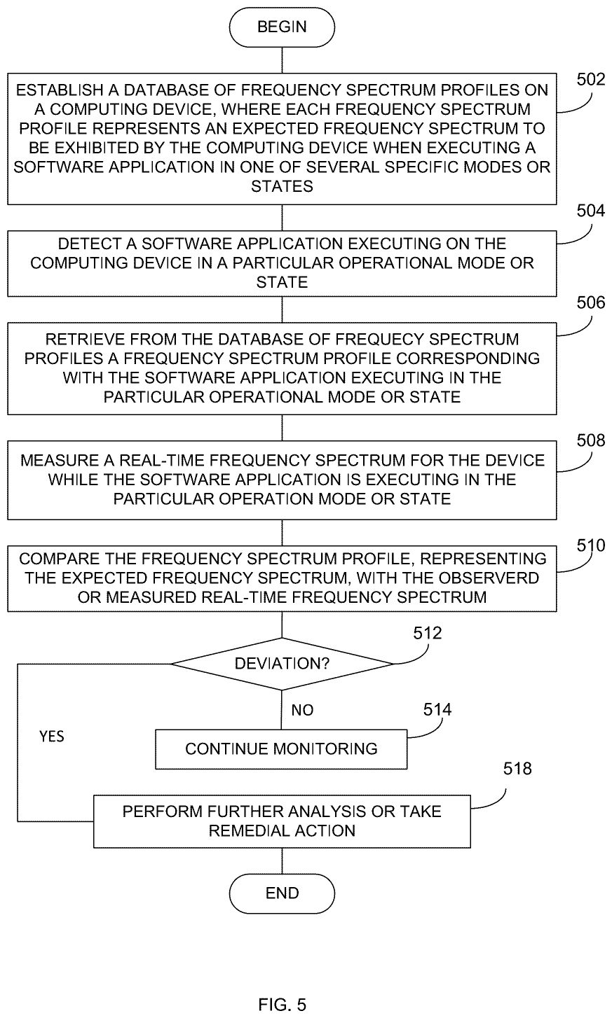

FIG. 5 is a flow diagram illustrating an example of a method for detecting anomalies based on a comparison of an expected frequency spectrum, as represented in a frequency spectrum profile, with an actual or observed frequency spectrum, consistent with embodiments of the invention. Method operation 502 in FIG. 5 involves identifying or establishing a local database on a target computing device, where the database contains frequency spectrum profile entries characterizing expected frequency spectrums for software applications executing in various operational modes or states. For example, common operational modes for applications may include: an idle state where the application is open but not actively being used; active communication states like audio calls, video calls, chat/messaging sessions, or conference calls; media playback states for streaming audio or video content; executing an interactive gaming application; actively transferring data; playing locally stored audio or video content; performing intensive computational tasks; and transitioning between operational modes.

With some embodiments, for each of several software applications installed on the target computing device, the database includes one or more corresponding frequency spectrum profiles. Each frequency spectrum profile represents the expected frequency spectrum that the overall device will exhibit when that particular software application is executing in a specific operational mode or state.

For instance, the frequency spectrum profile for a video conferencing application executing in an audio call state will differ from the spectrum for the same video conferencing application sharing screen content to remote participants. The database established in operation 502 maps software applications and operational modes to expected frequency spectrum profiles that serve as a baseline for comparison during real-time monitoring.

These frequency spectrum profiles that make up the database can be generated by directly measuring frequency spectrums for each application and operational mode combination on the target computing device itself when it is known to be secure and clean. Alternatively, the profiles can be pre-characterized on a separate clean test machine with the same hardware configuration prior to transfer and installation on the target device.

With some embodiments, the software developer may create a frequency spectrum profile that characterizes the application by running the program through profiling tools to sample its electromagnetic emissions in various operational modes. This produces the reference spectrum data. The developer then signs the frequency spectrum profile file with their private key and embeds this signed file within the application installation package. Upon first installation on a user's device, the software installation process validates the developer's signature on the included profile file using the developer's public key. Signature validation confirms the profile data is authentic and unmodified. The installation scripts add this verified profile for the application into the local database of frequency spectrum profiles used for anomaly detection. Any subsequent changes to the profile file stored locally will result in a signature mismatch versus the original signed profile, indicating potential tampering. This mechanism restricts the ability to alter an application's reference spectrum to evade detection, by leveraging cryptographic techniques to bind the profile data to the software author.

Method operation 504 involves detecting that a particular software application is executing on the computing device in a specific operational mode or state. For example, the operational state may represent that the application is facilitating an audio call, video call, gaming session, media playback, file transfer, or other function. There are a variety of techniques that the computing device could leverage to identify software applications currently executing and determine their operational states. Many operating systems (OS) provide application monitoring APIs that can be queried to retrieve lists of processes and services presently active. For instance, a call could be made to an operating system API that returns data specifying the names and identifiers of applications currently running.

Additionally, operating systems often include facilities for tracking resource utilization by individual applications over time. By analyzing the resources being accessed by an application process, such as network bandwidth, microphone, camera, GPU, etc., inferences can be made regarding the functional mode or state of the application. An application utilizing the camera and transmitting audio/video data is likely in a video calling state.

Method operation 506 involves retrieving, from the frequency spectrum profile database established in operation 502, the specific frequency spectrum profile that corresponds to the software application detected in operation 504 together with its identified operational mode or state. For example, if operation 504 detects that a video conferencing application is actively operating in an audio call state, then operation 506 would query the database for the frequency spectrum profile associated with that video conferencing application facilitating an audio call. Each entry in the database maps a software application and operational mode combination to an expected frequency spectrum profile.

At operation 506, the device performs a lookup in this mapping database using the software application and its mode/state detected in operation 504 to obtain the corresponding frequency spectrum profile that the device should exhibit. This baseline frequency spectrum profile retrieved at operation 506 represents the expected or reference spectrum when that software application executes in that particular operational mode.

Next, at method operation 508, the computing device obtains or measures the real-time frequency spectrum emanating from the device while the software application detected in operation 504 continues executing in the operational mode identified in operation 504. This yields an observed, actual frequency spectrum that can be compared against the expected frequency spectrum profile retrieved in operation 506.

In some examples, in order to measure the real-time frequency spectrum, the output of the baseband modulator inside the communications subsystem of the computing device is tapped. As described previously, the baseband modulator encodes the digital data from software applications into a complex baseband waveform that gets modulated onto a carrier signal for transmission. By tapping the output of the baseband modulator, the computing device obtains time-domain samples of the overall signal resulting from all software processes presently executing and imparting data onto the communication subsystem.

These tapped baseband samples are provided to a spectral analyzer, which, consistent with some embodiments, applies a Fast Fourier Transform algorithm. The Fast Fourier Transform algorithm converts the complex baseband time-domain signal into the frequency domain, revealing its frequency spectrum characteristics. The Fast Fourier Transform breaks down the overall signal into constituent frequencies and their corresponding amplitudes.

The spectral analyzer circuit can further process the FFT frequency data to isolate the frequencies and amplitudes that have the highest power levels and are least likely to represent noise. The remaining dominant frequency components comprise the observed real-time frequency spectrum emanating from the electronic device as its various software applications operate.

At method operation 510, the real-time frequency spectrum for the electronic device measured in operation 508 is compared against the reference frequency spectrum profile retrieved from the database in operation 506. This reference frequency spectrum represents the expected behavior for the software application operating in the detected mode/state. The comparison analyzes whether the real-time spectrum diverges from anticipated behavior.

At operation 512 a determination is made as to whether the real-time spectrum deviates significantly from the expected reference spectrum. Statistical techniques are used to allow for minor routine fluctuations but detect substantial mismatches. For example, the two spectrums may be analyzed over multiple time intervals to enable tolerance of some variability. However, if over a threshold percentage of the time windows the disparity between expected and observed spectrums is greater than an allowed deviation level, operation 512 determines deviation exists.

If no substantial, sustained mismatch is detected at operation 512, monitoring continues as normal in operation 514. However, if operation 512 determines that a significant discrepancy exists between the reference and measured frequency spectrums, then remedial action is initiated at operation 518. The specifics of the remedial response taken at 518 may depend on the degree of deviation. For more extreme anomalies indicating a high likelihood of malware, more disruptive actions like disconnecting network connectivity or shutting down the device may occur. Alternatively, a more power and CPU intensive virus scan operation may be performed. For lesser deviations, the action may involve logging the event, notifying the user, or running diagnostics.

### Machine and Software Architecture

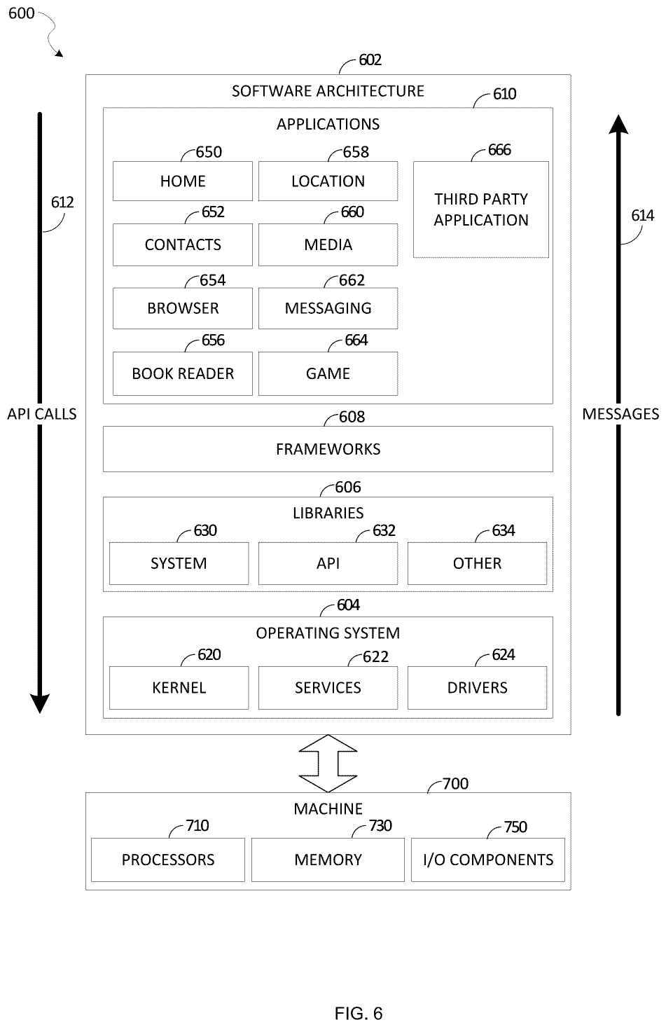

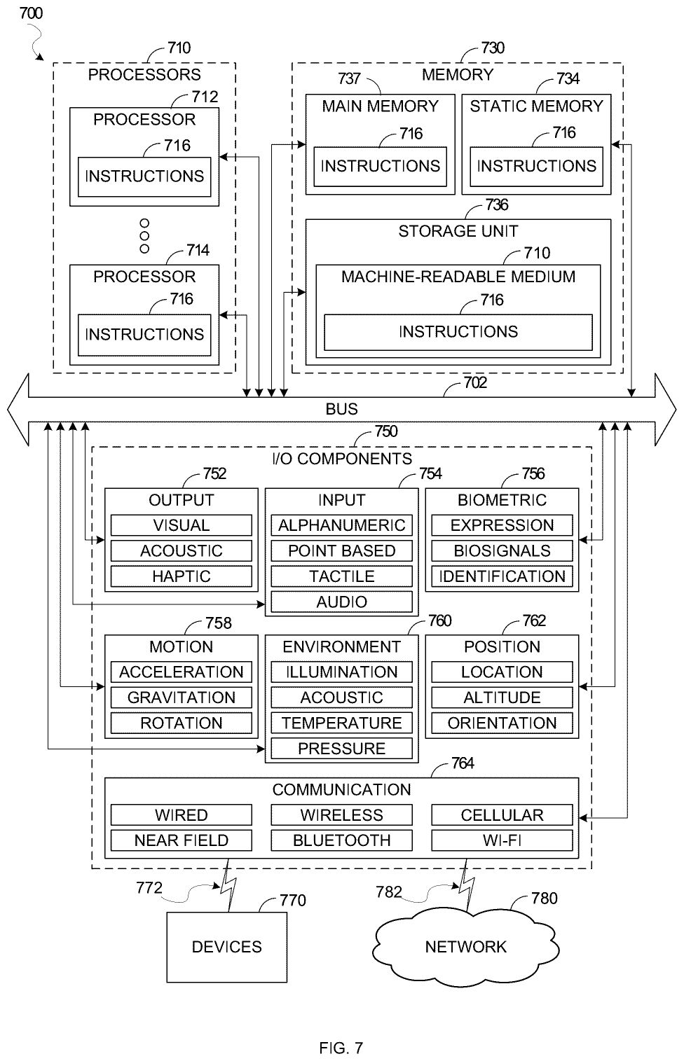

FIG. 6 is a block diagram 600 illustrating a software architecture 602, which can be installed on any of a variety of computing devices to perform methods consistent with those described herein. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 802 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 834 to provide many other APIs to the applications 610.

The frameworks 608 provide a high-level common infrastructure that can be utilized by the applications 610, according to some embodiments. For example, the frameworks 608 provide various GUI functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine to perform any one or more of the methodologies discussed herein, according to an example embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions 716 may cause the machine 700 to execute any one of the methods or algorithmic techniques described herein. Additionally, or alternatively, the instructions 716 may implement any one of the systems described herein. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 916 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory 730 may include a main memory 732, a static memory 734, and a storage unit 736, all accessible to the processors 710 such as via the bus 702. The main memory 730, the static memory 734, and storage unit 736 store the instructions 716 embodying any one or more of the methodologies or functions described herein. The instructions 916 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 757, environmental components 760, or position components 762, among a wide array of other components. For example, the biometric components 756 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 730, 732, 734, and/or memory of the processor(s) 710) and/or storage unit 736 may store one or more sets of instructions and data structures (e.g., software) embodying or utilized by any one or more of the methodologies or functions described herein. These instructions (e.g., the instructions 716), when executed by processor(s) 710, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method for detecting anomalous software behavior in an electronic device, the method comprising:
storing, in a memory of the electronic device, a plurality of frequency spectrum profiles, wherein each frequency spectrum profile corresponds with a software application executable by the electronic device and an operational mode of the software application;
detecting an operational mode of a software application executing on the electronic device;
retrieving, from the memory by a processor of the electronic device, a frequency spectrum profile corresponding with the software application and the detected operational mode;
measuring, by a sensor of the electronic device, a real-time frequency spectrum emanating from the electronic device while the software application executes in the detected operational mode, thereby yielding an observed real-time frequency spectrum;
comparing, by the processor, the observed real-time frequency spectrum with the retrieved frequency spectrum profile corresponding to the software application and the detected operational mode;
determining, by the processor based on the comparison, that a deviation exists between the observed real-time frequency spectrum and the frequency spectrum profile; and
performing, by the processor, one or more remedial actions based on determining that the deviation exists.

2. The method of claim 1, wherein determining that the deviation between the observed real-time frequency spectrum and the frequency spectrum profile indicates anomalous behavior comprises:
calculating a deviation metric representing a degree of deviation between the observed real-time frequency spectrum and the frequency spectrum profile over a plurality of time intervals;
comparing the deviation metric to a deviation threshold; and
determining that anomalous behavior exists only when the deviation metric exceeds the deviation threshold for at least a predetermined minimum number of the plurality of time intervals.

3. The method of claim 1, wherein the plurality of frequency spectrum profiles are obtained by querying a frequency spectrum profile database that includes, for each software application in a plurality of software applications, values for one or more frequency spectrum profiles corresponding to an operational state of the software application, the operational state representing a function being performed by the software application, the function comprising one of:
facilitating an audio-based communication session;
facilitating a video-based communication session;
streaming audio content;
streaming video content;
executing an interactive gaming application;
actively transferring data;
playing locally stored audio content;
playing locally stored video content;
performing an intensive computational task;
transitioning between two operational states; and
an idle state in which the application is open but not actively being used.

4. The method of claim 1, wherein measuring the real-time frequency spectrum emanating from the electronic device comprises:
tapping an output of a baseband modulator of the electronic device, the baseband modulator encoding data for transmission by the electronic device;
providing the tapped output of the baseband modulator to a spectral analyzer circuit;
applying, by the spectral analyzer circuit, a Fast Fourier Transform (FFT) to the tapped output of the baseband modulator, yielding FFT frequency data representing amplitude and phase information for a plurality of frequency components in the tapped baseband modulator output;
identifying, by the spectral analyzer circuit, a subset of the plurality of frequency components having an amplitude exceeding a predetermined amplitude threshold;
designating, by the spectral analyzer circuit, the subset of frequency components having the amplitudes exceeding the predetermined amplitude threshold as the observed real-time frequency spectrum emanating from the electronic device.

5. The method of claim 1, further comprising:
subsequent to determining that the deviation between the observed frequency spectrum and the frequency spectrum profile indicates anomalous behavior representing a high likelihood that an unknown software application is executing on the electronic device, automatically initiating an action comprising:
disconnecting the electronic device from a network;
shutting down the electronic device;
generating an alert message to a user of the electronic device;
switching execution of a software application to a different computing device;
initiating a corrective action in a client application executing on the electronic device;
initiating a corrective action in a backend server application communicating with the client application;
executing a predefined remedial procedure to address the anomalous frequency spectrum deviation; or
any combination thereof.

6. The method of claim 1, further comprising:
updating the plurality of frequency spectrum profiles stored in the memory by:
detecting a new software application installed on the electronic device;
prompting a user of the electronic device to execute the new software application such that each operational mode of the new software application is executed for a predetermined time period;
measuring, during the execution of each operational mode, a corresponding frequency spectrum profile emanating from the electronic device; and
storing the measured frequency spectrum profiles corresponding to each operational mode of the new software application in the memory as an updated plurality of frequency spectrum profiles.

7. The method of claim 1, further comprising:
subsequent to determining that the deviation between the observed frequency spectrum and the frequency spectrum profile indicates anomalous behavior, performing an analysis of processor utilization for software processes and services executing on the electronic device to identify any unknown processes correlated with the detected anomalous behavior.

8. A system for detecting anomalous software behavior in an electronic device, the system comprising:
at least one processor;
a memory storage device storing instructions thereon, which, when executed by the processor, causes the system to perform operations comprising:
storing, in the memory storage device, a plurality of frequency spectrum profiles, wherein each frequency spectrum profile corresponds with a software application executable by the electronic device and an operational mode of the software application;
detecting an operational mode of a software application executing on the electronic device;
retrieving, from the memory storage device, a frequency spectrum profile corresponding with the software application and the detected operational mode;
measuring, using a sensor, a real-time frequency spectrum emanating from the electronic device while the software application executes in the detected operational mode, thereby yielding an observed real-time frequency spectrum;
comparing the observed real-time frequency spectrum with the retrieved frequency spectrum profile corresponding to the software application and the detected operational mode;
determining, based on the comparison, that a deviation exists between the observed real-time frequency spectrum and the frequency spectrum profile; and
performing one or more remedial actions based on determining that the deviation exists.

9. The system of claim 8, wherein determining that the deviation between the observed real-time frequency spectrum and the reference frequency spectrum profile indicates anomalous behavior comprises:
calculating a deviation metric representing a degree of deviation between the observed real-time frequency spectrum and the reference frequency spectrum profile over a plurality of time intervals;
comparing the deviation metric to a deviation threshold; and
determining that anomalous behavior exists only when the deviation metric exceeds the deviation threshold for at least a predetermined minimum number of the plurality of time intervals.

10. The system of claim 8, wherein the plurality of frequency spectrum profiles are obtained by querying a frequency spectrum profile database that includes, for each software application in a plurality of software applications, values for one or more frequency spectrum profiles corresponding to an operational state of the software application, the operational state representing a function being performed by the software application, the function comprising one of:
facilitating an audio-based communication session; facilitating a video-based communication session;
streaming audio content; streaming video content; executing an interactive gaming application; actively transferring data;
playing locally stored audio content; playing locally stored video content;
performing an intensive computational task; transitioning between two operational states; and
an idle state in which the application is open but not actively being used.

11. The system of claim 8, wherein measuring the real-time frequency spectrum emanating from the electronic device comprises:
tapping an output of a baseband modulator of the electronic device, the baseband modulator encoding data for transmission by the electronic device; providing the tapped output of the baseband modulator to a spectral analyzer circuit;
applying, by the spectral analyzer circuit, a Fast Fourier Transform (FFT) to the tapped output of the baseband modulator, yielding FFT frequency data representing amplitude and phase information for a plurality of frequency components in the tapped baseband modulator output;
identifying, by the spectral analyzer circuit, a subset of the plurality of frequency components having an amplitude exceeding a predetermined amplitude threshold;
designating, by the spectral analyzer circuit, the subset of frequency components having the amplitudes exceeding the predetermined amplitude threshold as the observed real-time frequency spectrum emanating from the electronic device.

12. The system of claim 8, wherein the memory storage device is storing additional instructions, which, when executed by the processor, cause the system to perform further operations comprising:
subsequent to determining that the deviation between the observed frequency spectrum and the frequency spectrum profile indicates anomalous behavior representing a high likelihood that an unknown software application is executing on the electronic device, automatically initiating an action comprising:
disconnecting the electronic device from a network; shutting down the electronic device;
generating an alert message to a user of the electronic device; switching execution of a software application to a different computing device;
initiating a corrective action in a client application executing on the electronic device; initiating a corrective action in a backend server application communicating with the client application; executing a predefined remedial procedure to address the anomalous frequency spectrum deviation; or
any combination thereof.

13. The system of claim 8, wherein the memory storage device is storing additional instructions, which, when executed by the processor, cause the system to perform further operations comprising:
updating the plurality of frequency spectrum profiles stored in the memory storage device by:
detecting a new software application installed on the electronic device;
prompting a user of the electronic device to execute the new software application such that each operational mode of the new software application is executed for a predetermined time period;
measuring, during the execution of each operational mode, a corresponding frequency spectrum profile emanating from the electronic device; and
storing the measured frequency spectrum profiles corresponding to each operational mode of the new software application in the memory storage device as an updated plurality of frequency spectrum profiles.

14. The system of claim 8, wherein the memory storage device is storing additional instructions, which, when executed by the processor, cause the system to perform further operations comprising:
subsequent to determining that the deviation between the observed frequency spectrum and the frequency spectrum profile indicates anomalous behavior, performing an analysis of processor utilization for software processes and services executing on the electronic device to identify any unknown processes correlated with the detected anomalous behavior.

15. A non-transitory computer-readable medium storing instructions that, when executed by a processor of an electronic device, causes the processor to perform a method for detecting anomalous software behavior, the method comprising:
storing, in a memory of the electronic device, a plurality of frequency spectrum profiles, wherein each frequency spectrum profile corresponds with a software application executable by the electronic device and an operational mode of the software application;
detecting an operational mode of a software application executing on the electronic device;
retrieving, from the memory, a frequency spectrum profile corresponding with the software application and the detected operational mode;
measuring, by a sensor of the electronic device, a real-time frequency spectrum emanating from the electronic device while the software application executes in the detected operational mode, thereby yielding an observed real-time frequency spectrum;
comparing the observed real-time frequency spectrum with the retrieved frequency spectrum profile corresponding to the software application and the detected operational mode; determining, based on the comparison, that a deviation exists between the observed real-time frequency spectrum and the frequency spectrum profile; and
performing one or more remedial actions based on determining that the deviation exists.

16. The non-transitory computer-readable medium of claim 15, wherein determining that the deviation between the observed real-time frequency spectrum and the reference frequency spectrum profile indicates anomalous behavior comprises:
calculating a deviation metric representing a degree of deviation between the observed real-time frequency spectrum and the reference frequency spectrum profile over a plurality of time intervals; comparing the deviation metric to a deviation threshold; and
determining that anomalous behavior exists only when the deviation metric exceeds the deviation threshold for at least a predetermined minimum number of the plurality of time intervals.

17. The non-transitory computer-readable medium of claim 15, wherein the plurality of frequency spectrum profiles are obtained by querying a frequency spectrum profile database that includes, for each software application in a plurality of software applications, values for one or more frequency spectrum profiles corresponding to an operational state of the software application, the operational state representing a function being performed by the software application, the function comprising: facilitating an audio-based communication session;
facilitating a video-based communication session;
streaming audio content; streaming video content;
executing an interactive gaming application;
actively transferring data;
playing locally stored audio content;
playing locally stored video content;
performing an intensive computational task;
transitioning between two operational states; and
an idle state in which the application is open but not actively being used.

18. The non-transitory computer-readable medium of claim 15, wherein measuring the real-time frequency spectrum emanating from the electronic device comprises:
tapping an output of a baseband modulator of the electronic device, the baseband modulator encoding data for transmission by the electronic device;
providing the tapped output of the baseband modulator to a spectral analyzer circuit; applying, by the spectral analyzer circuit, a Fast Fourier Transform (FFT) to the tapped output of the baseband modulator, yielding FFT frequency data representing amplitude and phase information for a plurality of frequency components in the tapped baseband modulator output;
identifying, by the spectral analyzer circuit, a subset of the plurality of frequency components having an amplitude exceeding a predetermined amplitude threshold;
designating, by the spectral analyzer circuit, the subset of frequency components having the amplitudes exceeding the predetermined amplitude threshold as the observed real-time frequency spectrum emanating from the electronic device.

19. The non-transitory computer-readable medium of claim 15, the method further comprising: subsequent to determining that the deviation between the observed frequency spectrum and the frequency spectrum profile indicates anomalous behavior representing a high likelihood that an unknown software application is executing on the electronic device, automatically initiating an action comprising:
disconnecting the electronic device from a network;
shutting down the electronic device; generating an alert message to a user of the electronic device;
switching execution of a software application to a different computing device;
initiating a corrective action in a client application executing on the electronic device; initiating a corrective action in a backend server application communicating with the client application;
executing a predefined remedial procedure to address the anomalous frequency spectrum deviation; or
any combination thereof.

20. The non-transitory computer-readable medium of claim 15, the method further comprising:
updating the plurality of frequency spectrum profiles stored in the memory by:
detecting a new software application installed on the electronic device;
prompting a user of the electronic device to execute the new software application such that each operational mode of the new software application is executed for a predetermined time period;
measuring, during the execution of each operational mode, a corresponding frequency spectrum profile emanating from the electronic device; and
storing the measured frequency spectrum profiles corresponding to each operational mode of the new software application in the memory as an updated plurality of frequency spectrum profiles.
